(19) United States
(12) Patent Application Publication
(10) Pub. No.: US 2015/0016118 A1
(43) Pub. Date: Jan. 15, 2015

(54) LENS WITH DIFFERENT LAYERS AND LED UNIT USING THE SAME

(71) Applicant: HON HAI PRECISION INDUSTRY CO.,LTD., New Taipei (TW)

(72) Inventor: LI-YING WANG HE, Tu-Cheng (TW)

(73) Assignee: HON HAI PRECISION INDUSTRY CO., LTD., New Taipei (TW)

(21) Appl. No.: 14/010,549

(22) Filed: Aug. 27, 2013

(30) Foreign Application Priority Data
Jul. 15, 2013 (TW) 102125302

(51) Int. Cl. F21V 5/04; F21K 99/00

(52) U.S. Cl. CPC F21V 5/04; F21K 9/50
USPC 362/311.02; 362/335

(57) ABSTRACT

A lens includes a first optical layer, a second optical layer covering the first optical layer and a third optical layer covering the second optical layer. The first optical layer has a light refractive index larger than that of the second optical layer. The second optical layer has a light refractive index larger than that of the third optical layer.

### BACKGROUND

1. Technical Field

The disclosure generally relates to lenses, and more particularly to a lens having different layers and an LED (light emitting diode) unit using the lens.

2. Description of Related Art

Nowadays LEDs (light emitting diodes) are applied widely in various applications for illumination. The LED is a highly pointed light source. Thus, light directly emitted from the LED may form a small light spot. The small light spot can only illuminate a small area. Thus, in order to achieve a large illumination area, a large number of LEDs are required to be used, thereby increasing the illumination cost.

What is needed, therefore, is a lens having different layers and an LED unit using the lens which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 is an exploded view of a lens in accordance with an embodiment of the present disclosure.

FIG. 2 is an assembled view of the lens of FIG. 1.

FIG. 3 shows a cross section of the lens of FIG. 2 taken along line III-III thereof, wherein a light emitting diode is placed below the lens.

### DETAILED DESCRIPTION

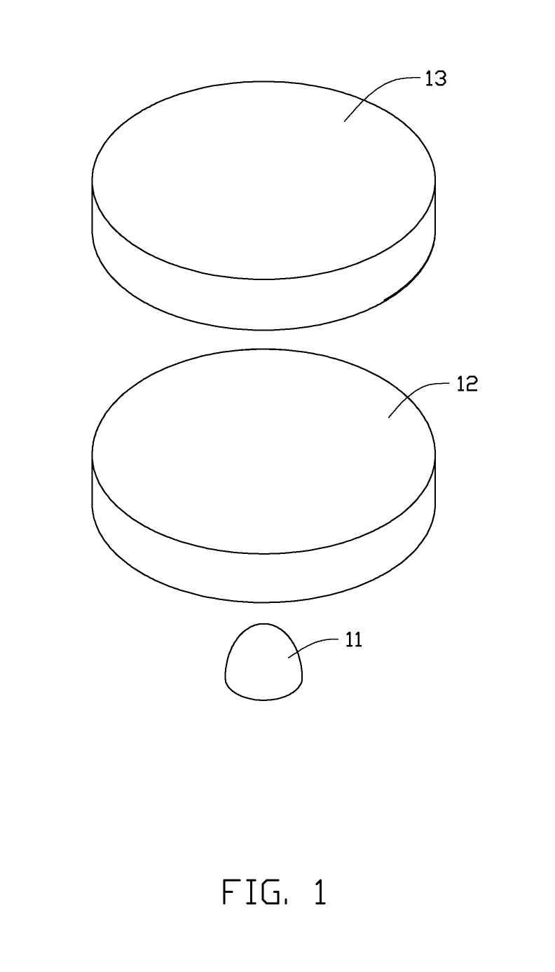

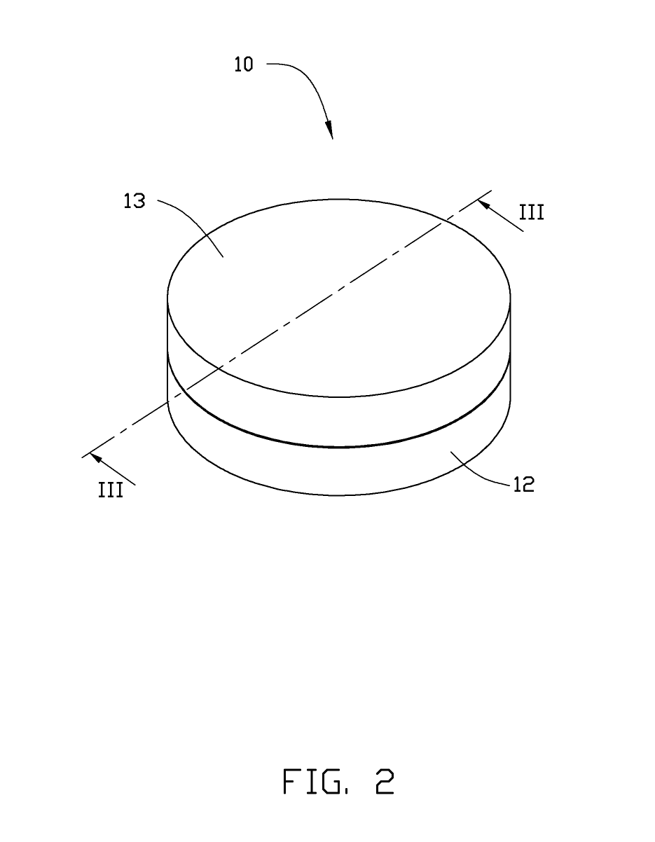

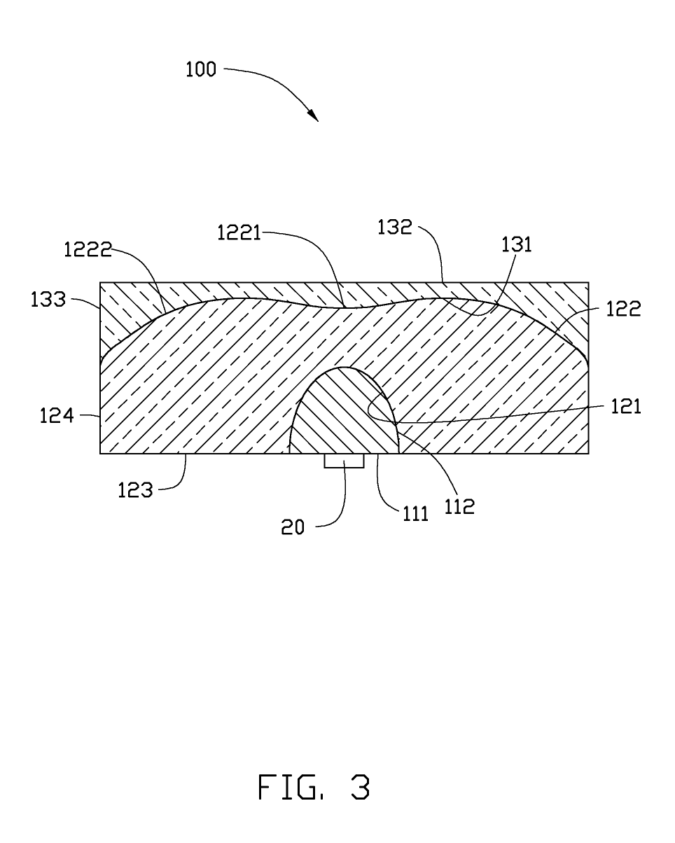

Referring to FIGS. 1-3, an LED unit 100 in accordance with an embodiment of the present disclosure is shown. The LED unit 100 includes a lens 10 and a light emitting diode 20 mounted below the lens 10. The lens 10 is used for modulating light emitted from the light emitting diode 20.

The lens 10 has a cylindrical shape. The lens 10 includes a first optical layer 11, a second optical layer 12 and a third optical layer 13 sequentially stacked. The first optical layer 11 is solid and has a dome shape. The first optical layer 11 has a flat bottom face 111 and an elliptical top face 112 connecting the bottom face 111. The bottom face 111 of the first optical layer 11 acts as a light incident face of the first optical layer 11, and the top face 112 of the first optical layer 11 acts as a light emerging face of the first optical layer 11. Light emitted from the light emitting diode 20 can enter the first optical layer 11 through the bottom face 111 and exit the first optical layer 11 through the top face 112.

The second optical layer 12 covers the first optical layer 11. The second optical layer 12 includes an inner face 121, an outer face 122 opposite to the inner face 121, an annular bottom face 123 and a lateral face 124 connecting the bottom face 123 with the outer face 122. The inner face 121 has a shape and a size equal to that of the top face 112 of the first optical layer 11. The inner face 121 is totally overlapped with the top face 112 of the first optical layer 11. The inner face 121 of the second optical layer 12 directly contacts the top face 112 of the first optical layer 11. The inner face 121 of the second optical layer 12 acts as a light incident face of the second optical layer 12. The outer face 122 is located above the inner face 121. The outer face 122 includes a concave face 1221 formed in a central area thereof and a convex face 1222 surrounding the concave face 1221. The concave face 1221 is located just above the first optical layer 11. The outer face 122 acts as a light emerging face of the second optical layer 12. The bottom face 123 of the second optical layer 12 is flat and annular.

The bottom face 123 of the second optical layer 12 is coplanar with and surrounds the bottom face 111 of the first optical layer 11. The lateral face 124 of the second lateral layer 12 is perpendicular to the bottom face 123. The lateral face 124 has a height larger than that of the first optical layer 11. The lateral face 124 is a cylindrical face surrounding the first optical layer 11. The second optical layer 12 has a light refractive index less than that of the first optical layer 11. Thus, the light emitted from the first optical layer 11 can be diverged at an interface between the top face 112 of the first optical layer 11 and the inner face 121 of the second optical layer 12. The diverged light further transmits out of the second optical layer 12 through the outer face 122 of the second optical layer 12.

The third optical layer 13 covers the second optical layer 12. The third optical layer 13 includes an inner face 131, an outer face 132 opposite to the inner face 131 and a side face 133 connecting the inner face 131 with the outer face 132. The inner face 131 of the third optical layer 13 has a shape and a size equal to that of the outer face 122 of the second optical layer 12. The inner face 131 of the third optical layer 13 is totally overlapped with the outer face 122 of the second optical layer 12. The inner face 131 of the third optical layer 13 directly contacts the outer face 122 of the second optical layer 12. The inner face 131 of the third optical layer 13 acts as a light incident face of the third optical layer 13. The outer face 132 of the third optical layer 13 is a flat face parallel to the bottom face 111 of the first optical layer 11. The outer face 132 of the third optical layer 13 has an area equal to a sum of that of the bottom faces 111, 123 of the first optical layer 11 and the second optical layer 12. The outer face 132 acts as a light emerging face of the third optical layer 13. The side face 133 of the third optical layer 13 is perpendicular to the outer face 132 of the third optical layer 13. The side face 133 of the third optical layer 13 is also a cylindrical face. The side face 133 of the third optical layer 13 is aligned with the lateral face 124 of the second optical layer 12. Thus, the side face 133 of the third optical layer 13 and the lateral face 124 of the second optical layer 12 cooperatively form a circumferential face of the lens 10. The side face 133 of the third optical layer 13 has an area less than that of the lateral face 124 of the second optical layer 12. The third optical layer 13 has a light refractive index less than that of the second optical layer 12. Thus, the diverged light emitted from the second optical layer 12 can be further diverged at an interface between the outer face 122 of the second optical layer 12 and the inner face 131 of the third optical layer 13. The further diverged light transmits out of the third optical layer 13 through the outer face 132 of the third optical layer 13. Therefore, the light emitted from the light emitting diode 20 can be diverged by the lens 10 to have a larger illumination area. Less light emitting diodes 20 are required to illuminate a large area when use with the lenses 10, thereby decreasing an illumination cost. The lens 10 is particularly suitable for use in a backlight module for illuminating a display.

The first optical layer 11, the second optical layer 12 and the third optical layer 13 may be made of different transparent materials for obtaining different refractive indexes. For example, the first optical layer may be made of ZF6 dense flint glass, the second optical layer may be made of polydimethylsiloxane, and the third optical layer may be made of polymethylmethacrylate.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A lens comprising:
a first optical layer comprising a first light incident face and a first light emerging face opposite to the first light incident face; and
a second optical layer receiving the first optical layer therein, the second optical layer comprising a second light incident face connecting the first light emerging face of the first optical layer, and a second light emerging face opposite to the second light incident face;
wherein the second optical layer has a light refractive index less than that of the first optical layer.

2. The lens of claim 1, wherein the second light incident face is totally overlapped with the first light emerging face.

3. The lens of claim 2, wherein the second light incident face directly contacts the first light emerging face.

4. The lens of claim 1, wherein the first light incident face comprises a flat bottom face of the first optical layer.

5. The lens of claim 1, wherein the first light emerging face comprises an elliptical top face of the first optical layer.

6. The lens of claim 1, wherein the second optical layer comprises a bottom face located between the second light incident face and the second light emerging face.

7. The lens of claim 6, wherein the bottom face of the second optical layer is coplanar with the first light incident face of the first optical layer.

8. The lens of claim 6, wherein the second optical layer comprises a lateral face interconnecting the bottom face and the second light emerging face.

9. The lens of claim 8, wherein the lateral face is perpendicular to the bottom face.

10. The lens of claim 8 further comprising a third optical layer covering the second optical layer, wherein the third optical layer has a light refractive layer less than that of the second optical layer.

11. The lens of claim 10, wherein the third optical layer comprises a third light incident face totally overlapped with the second light emerging face and a third light emerging face opposite to the third light incident face.

12. The lens of claim 11, wherein the third light emerging face is flat and parallel to the bottom face of the second optical layer.

13. The lens of claim 11, wherein the third light emerging face has an area equal to a sum of areas of the bottom face of the second optical layer and the first light incident face of the first optical layer.

14. The lens of claim 11, wherein the third optical layer comprises a side face interconnecting the third light incident face and the third light emerging face, the side face being aligned with the lateral face of the second optical layer.

15. An LED (light emitting diode) unit comprising:
an LED emitting light; and
a lens comprising a first optical layer, a second optical layer covering the first optical layer and a third optical layer covering the second optical layer;
wherein the first optical layer has a light refractive index larger than that of the second optical layer, and the second optical layer has a light refractive index larger than that of the third optical layer; and
wherein the light emitted from the LED is diverged when passing through an interface between the first optical layer and the second optical layer, and is further diverged when passing through an interface between the second optical layer and the third optical layer.

16. The LED unit of claim 15, wherein the first optical face comprises a bottom face, and the second optical layer comprises a bottom face coplanar with that of the first optical layer.

17. The LED unit of claim 15, wherein the second optical layer comprises a lateral face, and the third optical layer comprises a side face aligned with the lateral face of the second optical layer.

18. The LED unit of claim 16, wherein the third optical layer comprises a top face parallel to the bottom faces of the first optical layer and the second optical layer.

19. The LED unit of claim 15, wherein the lens has a cylindrical shape.

20. The LED unit of claim 15, wherein the first optical layer, the second optical layer and the third optical layer are made of different transparent materials.
